(19) United States
(12) Patent Application Publication
(10) Pub. No.: US 2014/0071292 A1
(43) Pub. Date: Mar. 13, 2014

(54) SYSTEM, METHOD, AND COMPUTER PROGRAM PRODUCT FOR OPTICALLY LIFTING A LATENT PRINT OVER A LONG DISTANCE

(71) Applicant: LOCKHEED MARTIN CORPORATION, Bethesda, MD (US)

(72) Inventor: Edward Jozef Miesak, Windermere, FL (US)

(73) Assignee: LOCKHEED MARTIN CORPORATION, Bethesda, MD (US)

(21) Appl. No.: 14/022,184

(22) Filed: Sep. 9, 2013

Related U.S. Application Data
(60) Provisional application No. 61/697,935, filed on Sep. 7, 2012.

(51) Int. Cl. G06K 9/00

(52) U.S. Cl. CPC G06K 9/00013
USPC 348/161

(57) ABSTRACT

A system including an imaging device, located a distance from a surface, configured to capture an image of a latent print or a contaminant on the surface at a first aspect ratio and with a first field of view on a surface, and a light emitting device, located a distance from the surface, configured to illuminate at a ultraviolet-c wavelength or a long wave infrared wavelength at the surface at a second aspect ratio equal to the first aspect ratio and with a shape of a field of view on the surface equal to the first field of view on the surface is disclosed. The captured image illustrates a reflected light image of the latent print or contaminant in a visible spectrum. A method and a non-transitory processor readable storage medium are also disclosed.

### CROSS-REFERENCE TO RELATED APPLICATIONS

This application claims the benefit of U.S. Provisional Application No. 61/697,935 filed Sep. 7, 2012, and incorporated herein by reference in its entire

### BACKGROUND

Embodiments relate to an imaging system and, more particularly, to a system and method to optically detect a latent print or contaminant upon a surface.

A latent print may be an invisible fingerprint impression, footprint impression, or palm print impression left on a surface following surface contact caused by the perspiration on ridges of an individual's skin coming in contact with the surface and leaving perspiration, sebum, waxes, oils, etc. behind, making an invisible or a partially visible impression on the surface as a result. Perspiration is known to contain water, salt, amino acids, and oils, which allows impressions to be made. The natural oils of the body preserve the print, where the impression left is utterly distinct so that no two humans have the same latent print.

Conventional methods for extracting fingerprints usually involve adding chemicals or powders to the print. Such conventional methods can present an immediate dilemma in that they force the investigator to make a decision as to whether to dust for prints versus swabbing for Deoxyribonucleic acid (“DNA”) evidence. Either approach results in destroying, or removing, the prints as they are originally found since the prints are no longer on their original surface.

Automatic non-contact latent fingerprint detection systems are also known that avoid the need to add chemicals or powders that can disturb the surface chemicals of the fingerprint. Such systems generally include a single light source, utilize diffuse reflectance ((reject specular reflection (glare)) and some may even use specular reflection, and are generally limited to fingerprinting the area of one's finger, or an area about that size. Furthermore, optically lifting a latent print occurs with an imaging system, and usually also the light emitting device, located a few inches, such as, but not limited to, 6 inches to 24 inches from a surface where a latent print is expected to exist. Such distances between the imaging device and surface are used because optical detection is usually critically dependent on image contrast and high resolution. Latent prints are very low contrast objects and therefore using only existing optical techniques when the print is on a rough surface is not practical. Optically lifting a finger print from a longer distance has not proven to be possible since sufficient resolution and sensitivity as is obtained at the closer distance has not been realized previously.

Entities desiring to detect latent prints at a longer distance would benefit from a system and method where a latent print may be optically detected and acquired without damaging the print while also providing resolution and sensitivity with sufficient clarity to identify an entity that made the print.

### SUMMARY

Embodiments relate to a system, method and computer program product to optically lift a latent print from a surface over a distance from the surface. The system comprises an imaging device, located a distance from a surface, configured to capture an image of a latent print or a contaminant on the surface at a first aspect ratio and with a first field of view on the surface. The system also comprises a light emitting device, located a distance from the surface, configured to illuminate at a ultraviolet-c wavelength or a long wave infrared wavelength at the surface at a second aspect ratio equal to the first aspect ratio and with a shape of a field of view on the surface equal to the first field of view on the surface. The captured image illustrates a reflected light image of the latent print or contaminant in a visible spectrum.

The method comprises illuminating a light at an ultraviolet-c wavelength or a long wave infrared wavelength with a light emitting device. The method also comprises illuminating the light, towards a surface where a latent print or a contaminant is located, with an illumination aspect ratio equal to an aspect ratio of an imaging device on the surface and with a shape of a field of view illuminated on the surface equal to a field of view of the imaging device on the surface. The method also comprises capturing an image of the latent print or contaminant with the captured image including a reflected light of the latent print or contaminant in a visible spectrum.

The computer program product is a non-transitory processor readable storage medium which provides an executable computer program product, the executable computer program product comprising a computer software code. When executed on a processor, the processor is caused to control a timing and a rate of illumination of a light emitting device emitting at a ultraviolet-c wavelength or a long wave infrared wavelength, the light emitting device is located at a distance from a latent print or a contaminant on a surface, with illumination emitted on the surface being equal to an aspect ratio of an imaging device at the surface and with an illumination shape being a shape of a field of view illuminated on the surface equal to equal to a field of view of the imaging device on the surface.

The processor is also caused to activate the imaging device, located a distance from the surface, to capture the image of the latent image or contaminant with the captured image including a reflected light of the latent print or contaminant in a visible spectrum.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 discloses a block diagram representing an embodiment of a system;

FIG. 2 discloses a plot illustrating transmission percentage versus wavelength in micrometers of an optical transmission curve of a particular fingerprint material;

FIG. 3 discloses a plot illustrating transmission percentage versus wavelength at ultraviolet wavelengths of particular fingerprint materials;

FIG. 4 discloses a block diagram representing an embodiment of components of the system disclosed in FIG. 1;

FIG. 5 discloses an illustration of a fingerprint image optically captured over a long distance;

FIG. 6 discloses an illustration of an enlarged view of one of the fingerprints illustrated in FIG. 5 optically captured over the long distance; and

FIG. 7 discloses a flowchart of a method.

### DETAILED DESCRIPTION

Embodiments are described herein with reference to the attached figures, wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. it should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found. in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Though embodiments are disclosed with respect to latent fingerprints, the embodiments are also applicable to other latent markings or prints as well, such as, but not limited to, a footprint, a palm print, etc. As used herein, “latent print” comprises a latent fingerprint and other imprints that may be recognizable to distinguish an entity from another. Latent fingerprints, which are impressions left by the friction ridges of a human finger, may be composed of almost any material, including, but not limited to, grease, oil, sweat, wax, etc. “Latent” as used with respect to fingerprints andlor other prints means a chance or accidental impression left on a surface, regardless of whether visible or invisible at time of deposition. Embodiments are also application to other surface contaminants. The term “contaminant” is not limited as it can also apply to a latent print. Other non-limiting examples of a contaminant may include blood or another body fluid, non-bodily fluids, oils, greases, dusts, dirt, water residue, other particulates, a fracture in a surface, a physical defect in the surface, etc.

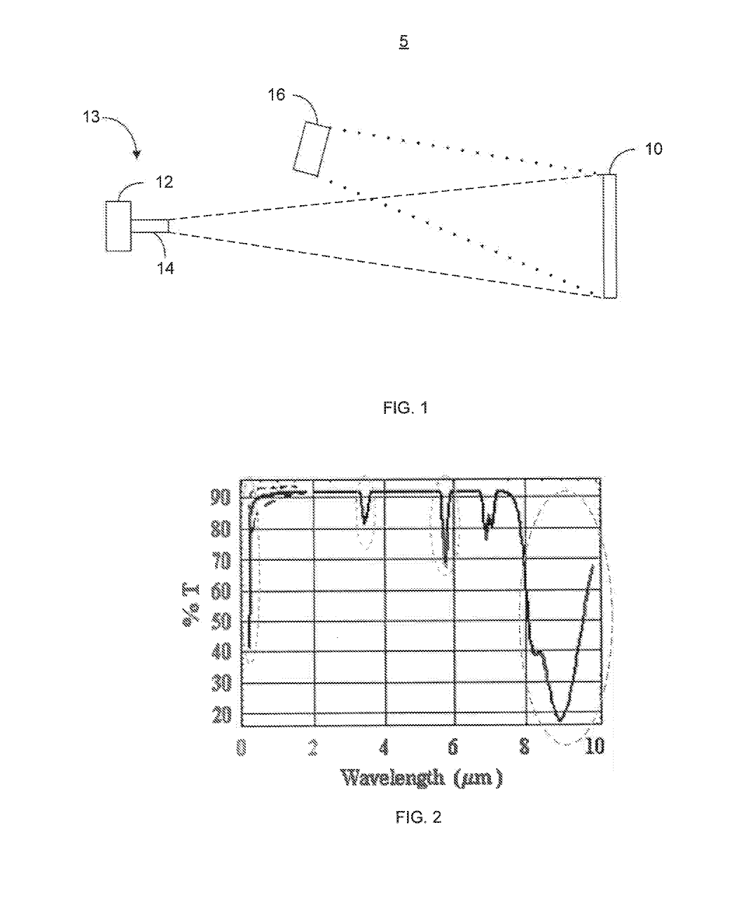

FIG. 1 discloses a block diagram representing an embodiment of a system for optically lifting a latent fingerprint over long distances. Though not a part of the system 5, a target 10 is disclosed. The target 10 may be a surface where a latent fingerprint(s) may exist. Since the target 10 is on a surface, these terms may be used interchangeably herein. As a part of the system 5, an imaging device 13 (illustrated further in FIG. 4), which may comprise a camera 12 and a lens 14 is provided. The lens 14 may be capable of providing clarity when imaging the target 10 from a given distance. More specifically, the imaging device 13 may provide a necessary resolution and sensitivity of the target 10 and clarity of a latent print found on the target in a visual spectrum when an image is captured of the target as disclosed herein. Thus, as used herein, “target” and “surface” may be used interchangeably. A non-limiting example of a type of lens which may be used is a 180 millimeter macro lens. A light emitting device 16, or light source, is also provided. In an embodiment, the light source 16 is located away from the target 10 and the camera 12 where a line of sight of the light source merges with a line of sight of the camera 12 prior to reaching the target 10.

The field of view of the imaging device 13 on the target overlaps with the illumination footprint wherein they are at a same shape and size on the target. As used herein, having a same shape and size includes a tolerance of approximately plus or minus ten percent (+/−10%).

A preferred distance for the light source 16 is at a location where when providing illumination, the illuminated light does not overfill the target 10 and/or location on the target 10 where the latent fingerprint may exist. Typically a light source used with a camera has a diverging lens such that a collimated beam of light passing through the lens is diverged or spread. In an embodiment, the light source 16 may be without a diverging lens so as to prevent an illuminated light from spreading (diverging) too fast, or to soon, from light source 16. Thus, the light propagates, such as, but not limited to through a lens, at a natural, normal or regular rate from the light source 16, or light emitting device, to the target or surface. In an embodiment, the lens 14 is configured to be adjusted to provide for illumination on the surface at a same aspect ratio of the imaging device 13 and with a shape of the illumination at a same size as the field of view of the imaging device on the surface. As explained above, a tolerance of approximately +/−10% is provided for in the use of the term “same.” In essence, the light source propagation may be manipulated so that the illumination footprint (aspect ratio and/or size) overlaps with a field of view of the imaging device on the surface and/or the aspect ratio of the imaging device.

As discussed above, the typical prior art distance an imaging device is placed from the target is usually 6 inches (or about 15 cm) to about 24 inches (or about 60 cm). As discussed herein, this distance is referred to as being proximate to the surface. This distance which is more than proximate to the surface, or the distance specific to the embodiments, may extend up to the capabilities of the imaging device 13 and light source 16, but a current recognized range is between approximately (or about) 0.6 meters up to about 3 meters. However, a maximum distance between the imaging device, or the light source, to the surface may be no more than a distance determined by a physical limitation which may cease to provide clarity in the captured image to determine an identification of the latent print or the contaminant.

Through experimentation, the inventor provided sufficient clarity of the ridges of a latent print for identification purposes with the light source 16 at about 5 feet, 4 inches (approximately 1.6 meters) from the target 10 and the end of the lens 14, with the other end attached to the camera 12, being about 8 feet, 8 inches (approximately 2.7 meters) from the target 10.

Depending on the distance, which is more than proximate to the surface, from which the latent image will be optically captured, a type of light source must be used to provide sufficient clarity of a latent print captured in an image for identification purposes. Two preferred light sources may be used. A first light source 16 option may produce ultraviolet-C (“UVC”) light and a second option may produce Long Wave Infrared (“LWIR”) light. A range for UVC light may be determined by a propagation loss of emitted light through the atmosphere since very short wavelength light is highly absorbed by the atmosphere. LWIR light may propagate much farther through the atmosphere than UVC, thus may be used further away from the target 10 than UVC light.

Though the light source 16 is illustrated as being at a certain location with respect to the camera 12, its location with respect to the camera is not limited. In one embodiment, the light source 16 may be located right next to the camera 12 and ideally would be built into a same case holding the camera 12. Furthermore, the light source may be aligned with a same, or nearly the same, field of view (“FOV”) of the camera 12.

FIG. 2 shows a plot illustrating transmission percentage versus wavelength in micrometers of an optical transmission curve of a particular fingerprint material, and is provided to further illustrate the optical transmission regions disclosed herein. Those skilled in the art will recognize that other materials may have plots which vary slightly. Four regions are identified as marked where lower option transmission exists. The region closest to zero micrometers is in the UVC region. The region between 8 micrometers to 15 micrometers is the LWIR region.

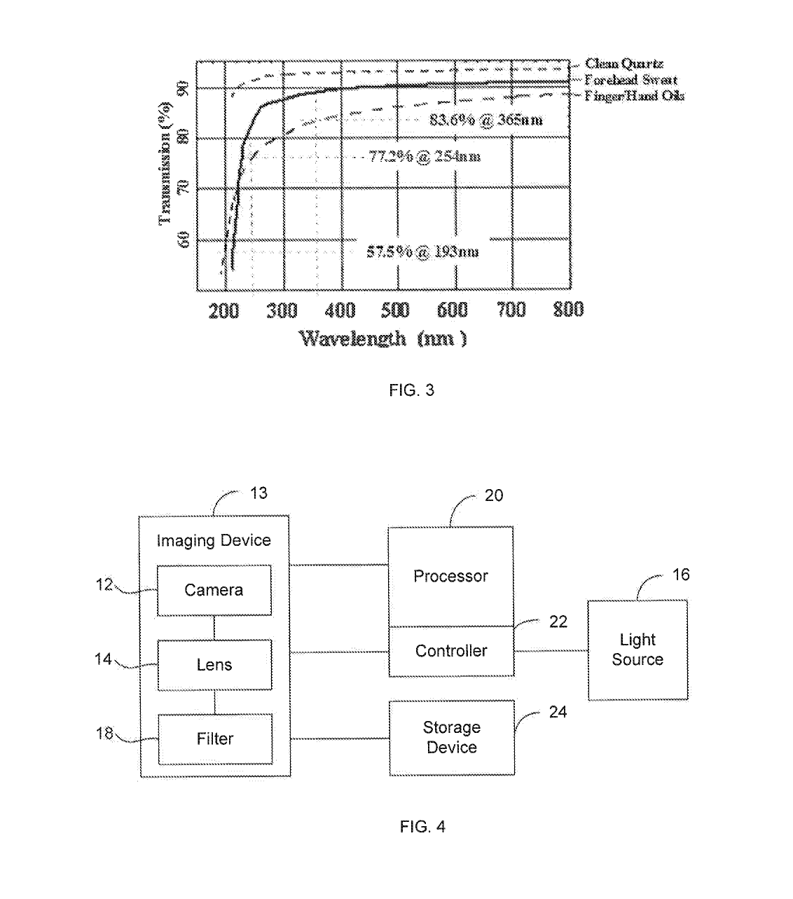

FIG. 3 shows a plot illustrating transmission percentage versus wavelength at ultraviolet wavelengths at a particular finger material. Those skilled in the art will recognize that other materials may have plots which vary slightly. Image contrast of latent prints is directly linked to their absorption. More specifically, the short wavelength portion. of a transmission spectrum is disclosed where absorption of material which makes up the latent print exceeds background material. As illustrated, optical transmission decreases rapidly as the optical wavelength enters the ultraviolet C region, namely, less than 280 nanometers. As illustrated, these plots represent clean quarts, forehead sweat, and oils typically found on an individual's fingers/hands.

FIG. 4 shows a block diagram representing an embodiment of components of the system disclosed in FIG. 1. The imaging device 13 is disclosed. The camera 12 may be a part of the imaging device 13. Also disclosed is the lens 14, which may also be a part of the imaging device 13, that is configured to obtain a clear image of the target 10 based on the distance the lens 14 is away from the target 10 so that friction ridges of the latent print in an image are viewable. In other words, clarity in a captured image is sufficient to determine an identification of the latent print or contaminant, in a visual spectrum. The lens 14 selection may also he based on the light source 16 used, such as, but not limited to, whether UVC or LWIR illumination is used, and/or the placement of the light source 16 with respect to the lens 14 (or imaging device 13) and/or target 10.

In an embodiment, the imaging device 13 captures images at the illuminated wavelength of a light emitted by the light source 16. An image capture may be accomplished by having a filter 18 in the line of sight of the camera 12 to the target 10 which is configured to cutoff, or reduce, any wavelengths longer than the illuminated wavelengths. Thus, the camera 12 may be able to view images in the wavelength of the illuminated light as well as in visible wavelengths.

In an embodiment, the filter may be a spectral filter 18 which is used when fluorescence is an issue with the material composing the latent image and/or a surface upon which the image is placed. The spectral filter 18 will prevent the camera 12 from picking up any fluorescence, in essence reduce the fluorescence from reaching the camera 12, that may be emitting from the latent fingerprint or sample surface. In operation. The light spectrum which is able to pass through the filter may match a portion of the spectrum of the light source 16.

In another embodiment, the image capture disclosed in U.S. Patent Publication No. 2011/059008 and U.S. Provisional Patent Application Nos. 61/530,306, 61/538,020, 61/602,950, 61/606,886, 61/602,956, and 61/606,898, each individually incorporated herein by reference, may be used in conjunction with a lens able to capture images from afar in combination with the camera 12 and light source 16.

A processor 20 is also disclosed. The processor 20 may be used to gather the data associated with the image taken by the camera 12. Also disclosed are a controller 22 and a storage device 24. The processor 20 may be a part of the controller 22. The controller 22 may be used to sync the illumination of the light source 16 with the camera 12 taking an image. More specifically, when a user is ready to take an image, activating the camera 12 to take the image is handled by the controller 22 where taking the image may be delayed so that the light source 16 illuminates the surface of the target 10 in advance of the image being taken. The camera 12 may also trigger the controller 22 which then activates the light source 16. Thus, the controller may initiate image capture and/or illumination. The delay may be established based on a distance of the lens 14 from the target 10 and placement of the light source 16 from both the lens 14 and the target 10. Another factor which may be included is the type of light source 16, UVC and/or LWIR, being used. These light sources may have different delays from their trigger to when their light leaves their enclosure. Captured images may then be stored in the storage device 24. The settings, such as, but not limited to, based on the type of light source, location of the imaging device 13 or elements of the imaging device with respect to the target 10, etc., may be stored in the storage device so that the imaging device may more readily capture other images where same or similar settings are realized instead of having to take time to make adjustments as if the similar or same environment had not been experienced previously. Regarding location of elements of the imaging device, the light source 16 may not be at a same location as the camera 12 and lens 14, thus this information is taken into account with respect to a setting.

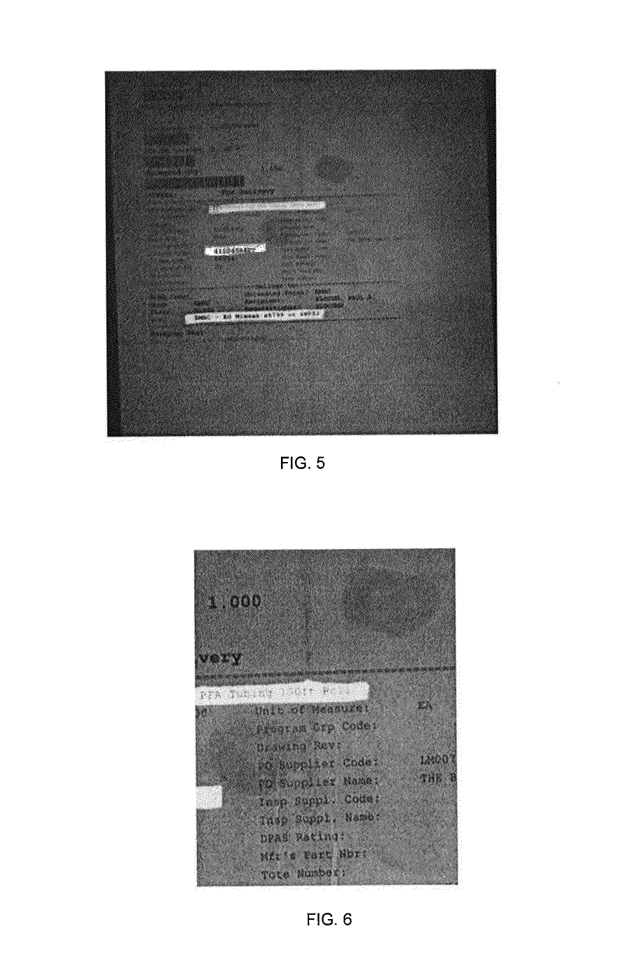

FIG. 5 shows an illustration of a fingerprint image optically captured over a long distance. The image was obtained when feasibility of the system was determined. Even though. the components used, as disclosed below, were designed to operate at closer ranges, generally a few inches from the target, using the system as disclosed herein resulted in imaging latent fingerprints at a range of several feet from both the camera and light source. More specifically, a camera with a 180 mm macro lens was set up focused on the target. The target was about 8 feet and 8 inches (approximately 2.64 meters) away from the lens. A light source was positioned about 5 feet and 4 inches (approximately 1.63 meters) away from the target. A diverging lens was not included with the light source to prevent the illuminating light from spreading too fast. More specifically, not having the diverging lens allowed for the light source to be able to be positioned farther away from the target. When the system was operated, the image of the target as the full Field of View (FOV) of the camera is achieved, as illustrated. Examination of the target shows that several latent fingerprints are visible. The FOV of the light source 16 may be very close to that of the camera. These distances are only provided to illustrate enablement and are not to be construed as limiting with respect to the embodiments disclosed herein.

FIG. 6 shows an illustration of an enlarged view of one of the fingerprints illustrated in FIG. 5 optically captured over the long distance. This image demonstrates greater detail of the quality of the fingerprint image taken with the system.

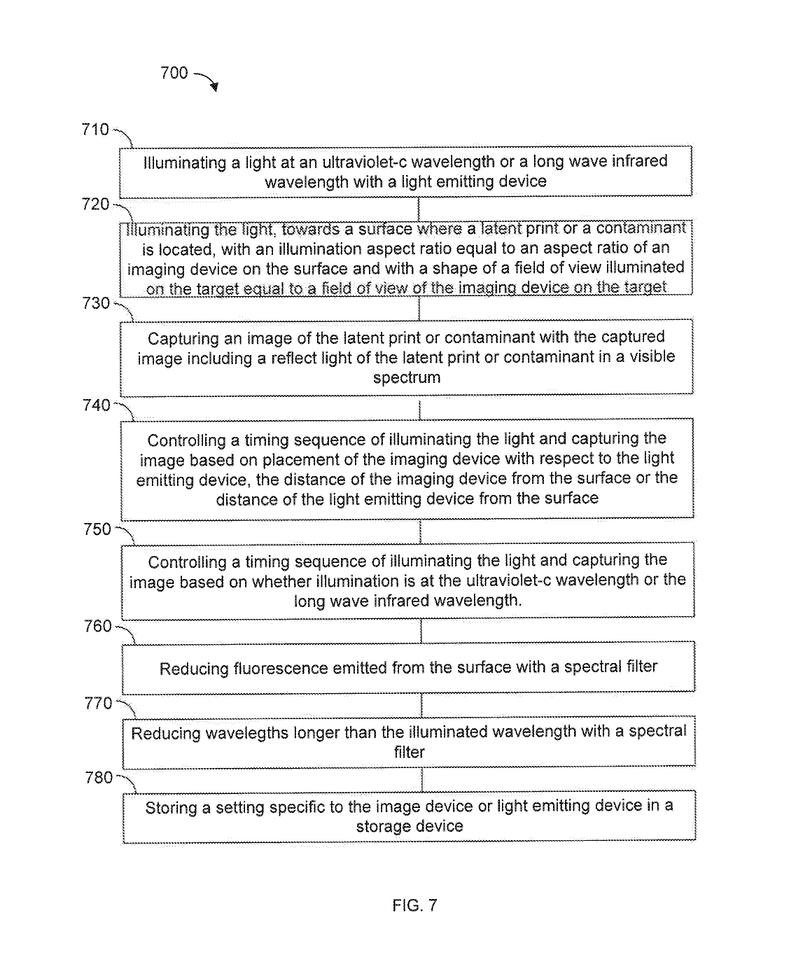

FIG. 7 shows a flowchart of a method for optically capturing an image over a long distance. The method 700 comprises illuminating a light at an ultraviolet-c wavelength or a long wave infrared wavelength with a light emitting device, at 710. The method further comprising illuminating the light, towards a surface where a latent print or a contaminant is located, with an illumination aspect ratio equal to an aspect ratio of an imaging device on the surface and with a shape of a field of view illuminated on the surface equal to a field of view of the imaging device on the surface, at 720. The method further comprising capturing an image of the latent print or contaminant with the captured image including a reflected light of the latent print or contaminant in a visible spectrum, at 730.

The method may further comprise controlling a timing sequence of illuminating the light and capturing the image based on placement of the imaging device with respect to the light emitting device, the distance of the imaging device from the surface or the distance of the light emitting device from the surface, at 740. The method may further comprise controlling a timing sequence of illuminating the light and capturing the image based on whether illumination is at the ultraviolet-c wavelength or the long wave infrared wavelength, at 750. The method may further comprise reducing fluorescence emitted from the surface with a spectral filter, at 760. The method may further comprise reducing a wavelength longer than an illuminated wavelength with a spectral filter, at 770. The method may further comprise storing a setting specific to the imaging device or light emitting device in a storage device, at 780. The distance from the surface is approximately 0.6 meters to approximately 3 meters.

Though the steps illustrated in the flowchart of the method 700 are provided in a particular sequence, this sequence is not meant to be limiting as those skilled in the art will recognize that these steps may be performed in any particular order. By applying the method and/or using an embodiment of the system disclosed herein, the latent fingerprints are not disturbed. Thus, there is no need to apply dusting, super-glue fuming, and/or other non-optical imaging techniques which result in material coming into direct contact with the latent image. Furthermore, possibilities exist to acquire images of the latent prints when a user may be unable to get close to the surface where the latent print is located.

Persons skilled in the art will recognize that an apparatus, such as a data processing system, including a CPU, memory, I/O, program storage, a connecting bus, and other appropriate components, could be programmed or otherwise designed to facilitate the practice of embodiments of the method. Such a system would include appropriate program means for executing the method. Also, an article of manufacture, such as a pre-recorded disk, computer readable media, or other similar computer program product, for use with a data processing system, could include a storage medium and program means recorded thereon for directing the data processing system to facilitate the practice of the method.

Embodiments may also be described in the general context of computer-executable instructions, such as program modules, being executed by any device such as, but not limited to, a computer, designed to accept data, perform prescribed mathematical and/or logical operations usually at high speed, where results of such operations may or may not be displayed. Generally, program modules include routines, programs, objects, components, data structures, etc., that perform particular tasks or implement particular abstract data types. In an embodiment, the software programs that underlie embodiments can be coded in different programming languages for use with different devices, or platforms. It will be appreciated, however, that the principles that underlie the embodiments can be implemented with other types of computer software technologies as well.

Moreover, those skilled in the art will appreciate that the embodiments may be practiced with other computer system configurations, multiprocessor systems, microprocessor-based or programmable consumer electronics, minicomputers, mainframe computers, and the like. Embodiments may also be practiced in distributed computing environments where tasks are performed by processing devices located at different locations that are linked through at least one communications network. In a distributed computing environment, program modules may be located in both local and remote computer storage media including memory storage devices.

In view of the above, a non-transitory processor readable storage medium is provided. The storage medium comprises an executable computer program product which further comprises a computer software code that, when executed on a processor, causes the processor perform certain steps or processes.

Thus, the non-transitory processor readable storage medium may cause the processor to control a timing and a rate of illumination of a light emitting device emitting at a ultraviolet-c wavelength or a long wave infrared wavelength, the light emitting device is located at a distance from a latent print or a contaminant on a surface, with illumination emitted on the surface being equal to an aspect ratio of an imaging device at the surface and with an illumination shape being a shape of a field of view illuminated on the surface equal to equal to a field of view of the imaging device on the surface. The processor is also caused to activate the imaging device, located a distance from the surface, to capture the image of the latent image or contaminant with the captured image including a reflected light of the latent print or contaminant in a visible spectrum.

The processor may also be controlled to control a timing and a rate of illumination and activation of the imaging device based on whether illumination is at the ultraviolet-c wavelength or the long wave infrared wavelength, or to control a timing and a rate of illumination and activation of the imaging device based on the distance the imaging device or light emitting device from the surface.

While various disclosed embodiments have been described above, it should be understood that they have been presented by way of example only, and not as a limitation. Numerous changes to the subject matter disclosed herein can be made in accordance with the embodiments disclosed herein without departing from the spirit or scope of the embodiments. In addition, while a particular feature may have been disclosed with respect to only one of several implementations, such feature may be combined with one or more other features of the other implementations as may be desired and advantageous for any given or particular application.

Therefore, the breadth and scope of the subject matter provided herein should not be limited by any of the above explicitly described embodiments. Rather, the scope of the embodiments should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Thus, while embodiments have been described with reference to various embodiments, it will be understood by those skilled in the art that various changes, omissions and/or additions may be made and equivalents may be substituted for elements thereof without departing from the spirit and scope of the embodiments. In addition, many modifications may be made to adapt a particular situation or material to the teachings of the embodiments without departing from the scope thereof. Therefore, it is intended that the embodiments not be limited to the particular embodiment disclosed as the best mode contemplated, but that all embodiments falling within the scope of the appended claims are considered.

What is claimed is:

1. A system comprising:
an imaging device, located a distance from a surface, configured to capture an image of a latent print or a contaminant on the surface at a first aspect ratio and with a first field of view on the surface; and
a light emitting device, located a distance from the surface, configured to illuminate at a ultraviolet-c wavelength or a long wave infrared wavelength at the surface at a second aspect ratio equal to the first aspect ratio and with a shape of a field of view on the surface equal to the first field of view on the surface;
wherein the captured image illustrates a reflected light image of the latent print or contaminant in a visible spectrum.

2. The system according to claim 1, wherein the distance from the surface is approximately 0.6 meters to approximately 3 meters.

3. The system according to claim 1, wherein the imaging device further comprises a lens configured provide for the imaging device to capture the image of the latent print where identification from the latent print or contaminant is determinable.

4. The system according to claim 1, wherein the light emitting device comprises a lens configured to be adjusted to provide for illumination on the surface with the second aspect ratio equal to the first aspect ratio and with the shape of the field of view of an illumination on the surface equal to the first field of view.

5. The system according to claim 1, further comprising a controller configured to initiate illumination from the light emitting device and image capture by the imaging device based on location of the imaging device with respect to the light emitting device.

6. The system according to claim 1, further comprising a controller configured to initiate illumination from the light emitting device and image capture by the imaging device based on whether illumination is at the ultraviolet-c wavelength or the long wave infrared wavelength.

7. The system according to claim 1, wherein the ultraviolet-c wavelength comprises a wavelength less than about 206 nanometers and the long wave infrared wavelength comprises a wavelength between about 8 micrometers and about 15 micrometers.

8. The system according to claim 1, further comprising a spectral filter configured to reduce fluorescence emitted from the surface when the image is captured.

9. The system according to claim 1, further comprising a spectral filter configured to reduce wavelengths longer than the illuminated wavelength from reaching the imaging device when the image is captured.

10. The system according to claim 1, wherein the distance from the surface is no more than a distance determined by a physical limitation in the imaging device or light emitting device which ceases to provide clarity in the captured image to determine an identification of the latent print or the contaminant.

11. A method comprising:
illuminating a light at an ultraviolet-c wavelength or a long wave infrared wavelength with a light emitting device;
illuminating the light, towards a surface where a latent print or a contaminant is located, with an illumination aspect ratio equal to an aspect ratio of an imaging device on the surface and with a shape of a field of view illuminated on the surface equal to a field of view of the imaging device on the surface; and
capturing an image of the latent print or contaminant with the captured image including a reflected light of the latent print or contaminant in a visible spectrum.

12. The method according to claim 11, further comprising controlling a timing sequence of illuminating the light and capturing the image based on placement of the imaging device with respect to the light emitting device, the distance of the imaging device from the surface or the distance of the light emitting device from the surface.

13. The method according to claim 11, further comprising controlling a timing sequence of illuminating the light and capturing the image based on whether illumination is at the ultraviolet-c wavelength or the long wave infrared wavelength.

14. The method according to claim 11, further comprising reducing fluorescence emitted from the surface with a spectral filter.

15. The method according to claim 11, further comprising reducing a wavelength longer than an illuminated wavelength with a spectral filter.

16. The method according to claim 11, wherein the distance from the surface is approximately 0.6 meters to approximately 3 meters.

17. The method according to claim 11, further comprising storing a setting specific to the imaging device or light emitting device in a storage device.

18. A non-transitory processor readable storage medium, providing an executable computer program product, the executable computer program product comprising a computer software code that, when executed on a processor, causes the processor to:
control a timing and a rate of illumination of a light emitting device emitting at a ultraviolet-c wavelength or a long wave infrared wavelength, the light emitting device is located at a distance from a latent print or a contaminant on a surface, with illumination emitted on the surface being equal to an aspect ratio of an imaging device at the surface and with an illumination shape being a shape of a field of view illuminated on the surface equal to equal to a field of view of the imaging device on the surface; and
activate the imaging device, located a distance from the surface, to capture the image of the latent image or contaminant with the captured image including a reflected light of the latent print or contaminant in a visible spectrum.

19. The non-transitory processor readable storage medium according to claim 18, when executed on a processor, further causes the processor to control a timing and a rate of illumination and activation of the imaging device based on whether illumination is at the ultraviolet-c wavelength or the long wave infrared wavelength.

20. The non-transitory processor readable storage medium according to claim 18, when executed on a processor, further causes the processor to control a timing and a rate of illumination and activation of the imaging device based on the distance the imaging device or light emitting device from the surface.
